(19) United States
(12) Patent Application Publication
(10) Pub. No.: US 2025/0098042 A1
(43) Pub. Date: Mar. 20, 2025

(54) LED LIGHTING DEVICE

(71) Applicant: Easysignal Inc., Chungcheongbuk-do (KR)

(72) Inventors: Soon Gu HONG, Chungcheongbuk-do (KR); Soon Hee HONG, Chungcheongbuk-do (KR)

(21) Appl. No.: 18/370,498

(22) Filed: Sep. 20, 2023

(51) Int. Cl. H05B 45/14; H05B 45/24; H05B 45/325; H05B 45/39; H05B 45/59

(52) U.S. Cl. CPC H05B 45/14; H05B 45/24; H05B 45/325; H05B 45/39; H05B 45/59

(57) ABSTRACT

A LED lighting device includes an LED unit including a first LED string made by connecting a plurality of first LEDs emitting light at a first color temperature in series and a second LED string made by connecting a plurality of second LEDs emitting light at a second color temperature different from the first color temperature in series. The first LED string and the second LED string are connected in inverse-parallel. A converter unit is configured to supply a DC voltage to the first LEDs and the second LEDs. A signal control unit is configured to output a first control signal for emitting light of the first LEDs and a second control signal for emitting light of the second LEDs in consideration of the difference in operating voltage according to the color temperature of the first LEDs and the color temperature of the second LEDs.

### TECHNICAL FIELD

This disclosure relates to an LED lighting device, and more particularly, to an LED lighting device which controls a plurality of light emitting diodes having different color temperatures.

### BACKGROUND

Recently, LED (light-emitting diode) lighting devices, which have an excellent energy saving effects and are environmentally friendly, come into the spotlight. LED lighting devices usually include light emitting elements having one color temperature. Accordingly, the user may control the brightness of the light emitting elements having one color temperature.

On the other hand, LED lighting devices which include a plurality of light emitting elements having different color temperatures for a special purpose have been released. Such LED lighting devices may include a plurality of light emitting elements having at least two color temperatures among light bulb color (e.g., 2700K to 3000K), daylight color (e.g., 4000K to 4500K), and daylight blue color (e.g., 5700K to 6500K). In these LED lighting devices, users may individually adjust the brightness of light emitting elements having respective color temperatures, and also change the color temperature of lighting in a space, for example, a kitchen, by adjusting the color temperature emitted from each light emitting element.

In general, in some of these LED lighting devices, a plurality of LEDs are connected in series, and a voltage greater than the product of the number of LEDs connected in series and the rated voltage of the LEDs is supplied to the plurality of LEDs connected in series. At this time, a resistor is provided on the line through which the LED current flows and serves to limit the current. However, LEDs have different rated voltages for each color, and after turning on, the voltage change is small and the current change is large.

### SUMMARY OF THE DISCLOSURE

### Technical Problem

In order to resolve the above problems, an object of this disclosure is to provide an LED lighting device capable of controlling a plurality of light emitting diodes having different color temperatures in consideration of the rated voltage according to the color temperature of the LED.

In addition, an object of this disclosure is to provide an LED lighting device capable of reducing flicker that may occur when a plurality of LED strings are connected in parallel.

In addition, an object of this disclosure is to provide an LED lighting device capable of improving noise immunity and removing a separate voltage during an LED driving operation.

### Technical Solution

According to an embodiment, A LED lighting device may comprise: an LED unit comprising a first LED string made by connecting a plurality of first LEDs emitting light at a first color temperature in series and a second LED string made by connecting a plurality of second LEDs emitting light at a second color temperature different from the first color temperature in series, wherein the first LED string and the second LED string may be connected in inverse-parallel; a converter unit configured to supply a DC voltage to the first LEDs and the second LEDs; a signal control unit configured to output a first control signal for emitting light of the first LEDs and a second control signal for emitting light of the second LEDs in consideration of the difference in operating voltage according to the color temperature of the first LEDs and the color temperature of the second LEDs, wherein the signal control unit configured to output the first control signal and the second control signal as PWM (Pulse Width Modulation) signals; and a LED driving unit configured to provide the DC voltage supplied from the converter unit to the first LEDs or the second LEDs by turning on or off a plurality of switches according to the first control signal or the second control signal.

According to a further embodiment, wherein the LED unit may comprise at least one resistor connected to the inside or outside of the first LED string and the second LED string connected in inverse-parallel, and a current flowing through the first LED string and the second LED string may flow in both directions through the at least one resistor.

According to a further embodiment, wherein the resistance value of the at least one resistor may be selected within a predetermined range of a value obtained by dividing the sum of currents flowing through the first LED string and the second LED string by 2.

According to a further embodiment, wherein The LED driving unit may comprise a full bridge circuit consisting of four switches.

According to a further embodiment, wherein upper switches of the full bridge circuit may be P-channel transistors, and lower switches of the full bridge circuit may be N-channel transistors.

According to a further embodiment, wherein the color temperature of the first LEDs may be a light bulb color, and the color temperature of the second LEDs may be a daylight blue color.

According to a further embodiment, wherein an on-time of the first control signal for emitting the first LEDs may be longer than an on-time of the second control signal for emitting the second LEDs when the first LEDs and the second LEDs alternately emit light to display the same brightness, respectively.

According to a further embodiment, wherein the on-time of the first control signal may be shorter than a value obtained by dividing by 2 an on-time of the same brightness in which only the first LEDs may be turned on and the on-time of the second control signal may be longer than a value obtained by dividing by 2 an on-time of the same brightness in which only the second LEDs may be turned on.

According to a further embodiment, wherein the signal control unit may be configured to output the first control signal and the second control signal by compensating for nonlinearity recognized by the human eye when controlling the brightness of each of the first LEDs and the second LEDs.

According to a further embodiment, wherein an LED branch may comprise the first LED string, the second LED string and at least one resistor, and at least one capacitor may be connected to prevent flicker between one end of at least one LED branch of the plurality of LED branches and the DC voltage side or the ground voltage side supplied from the converter unit.

According to a further embodiment, wherein both ends of a first LED branch among the plurality of LED branches may be directly connected to the DC voltage side and the ground voltage side supplied from the converter unit, a first capacitor may be connected between one end of the second LED branch and the DC voltage side of the converter, a second capacitor may be connected between one end of the third LED branch and the ground voltage side of the converter unit, and one end of the fourth LED branch may be connected to a node to which the second LED branch and the first capacitor are connected and the other end of the fourth LED branch may be connected to a node to which the third LED branch and the second capacitor are connected.

According to a further embodiment, wherein the capacitance value of the second capacitor may be twice as large as the capacitance value of the first capacitor.

According to a further embodiment, wherein the LED driving unit further may comprise a driving circuit configured to drive a first P-channel transistor of a first line with an on signal of a second N-channel transistor of a second line.

According to a further embodiment, wherein the driving circuit may comprise a complementary transistor set comprised of an NPN transistor and a PNP transistor to drive the first P-channel transistor.

According to a further embodiment, wherein the driving circuit further may comprise a first resistor connected between the DC voltage supplied from the converter unit and a base of the first P-channel transistor or a second resistor connected between an output of the complementary transistor set and the base of the first P-channel transistor.

### Advantageous Effects

According to various embodiments of this disclosure, a color temperature may be displayed closer to a color temperature desired by a user in displaying a color temperature by a combination of different color temperatures in an LED lighting device.

In addition, flicker may be reduced that may occur when a plurality of LED strings are connected in parallel by adding a capacitor to the LED branch.

In addition, noise immunity may be improved and a separate voltage may be eliminated by using a P-channel transistor as an upper switch and an N-channel transistor as a lower switch.

### BRIEF DESCRIPTION OF THE DRAWINGS

FIG. 1 illustrates a block diagram of an LED lighting device according to an embodiment of this disclosure.

FIG. 2 illustrates an implementation example of the LED unit illustrated in FIG. 1.

FIG. 3 illustrates an implementation example of the LED driving unit illustrated in FIG. 1.

FIG. 4 illustrates an implementation example of an LED unit to which a capacitor is added to reduce flicker according to another embodiment of this disclosure.

FIG. 5 illustrates an implementation example of an LED driving unit having a push-pull circuit according to another embodiment of this disclosure.

### DETAILED DESCRIPTION

Hereinafter, the various embodiments of an LED lighting device according to this disclosure will be described with reference to the accompanying drawings.

In particular, the terms referring to each component in this disclosure are terms defined in consideration of the functions of the components, and thus it should not be understood that the technical content of this disclosure is predicted and limited by the terms themselves.

Furthermore, the various embodiments of this disclosure to be described below are intended only to show the technical details of this disclosure, and the scope of protection of this disclosure is to be construed in accordance with the accompanying claims. Furthermore, one having ordinary skilled in the technical field to which this disclosure belongs will be able to design various modifications and variations without departing from the essential features of this disclosure, and the scope of this disclosure should be construed to cover all the technical ideas that are equal within the scope of this disclosure.

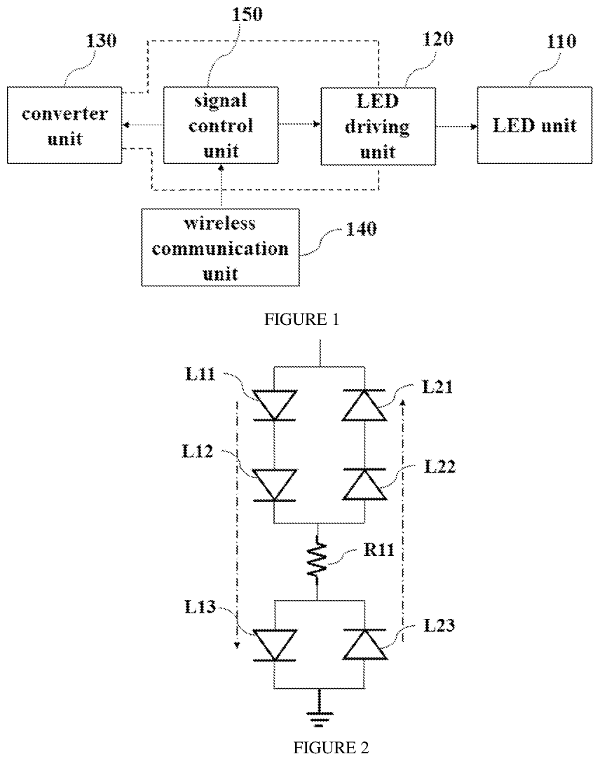

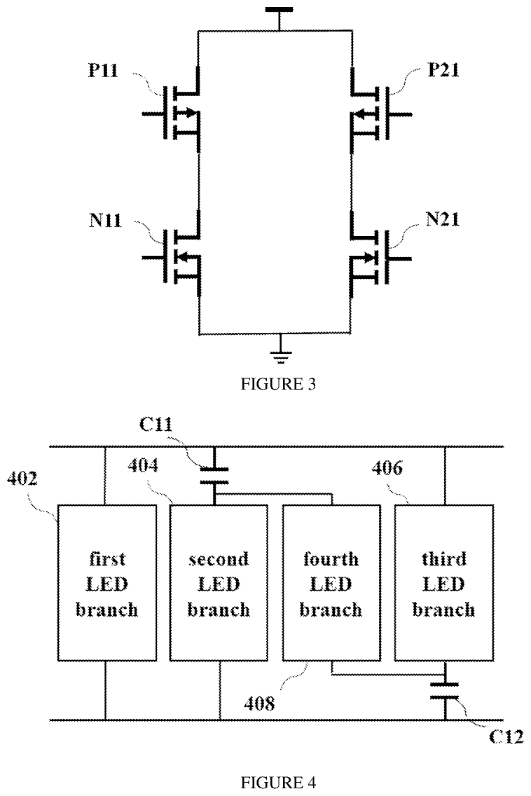

FIG. 1 illustrates a block diagram of an LED lighting device according to an embodiment of this disclosure, FIG. 2 illustrates an implementation example of the LED unit illustrated in FIG. 1, and FIG. 3 illustrates an implementation example of the LED driving unit illustrated in FIG. 1.

Referring to FIG. 1, the LED lighting device according to this disclosure includes an LED unit 110, an LED driving unit 120, a converter unit 130, a wireless communication unit 140, and a signal control unit 150.

The LED unit 110 includes a plurality of LEDs having different color temperatures. An implementation example of the LED unit 110 is illustrated in FIG. 2.

Referring to FIG. 2, the first color temperature LEDs L11, L12, and L13, for example, the daylight blue LEDs, are connected in series in the same direction so that the daylight blue color LEDs are turned on at the same time (hereinafter, referred to as ‘daylight blue color LED string’), and the second color temperature LEDs L21, L22, and L23, for example, light bulb color LEDs, are also connected in series in the same direction so that the light bulb color LEDs are turned on at the same time (hereinafter, referred to as ‘light bulb color LED string’).

Referring to FIG. 2, the daylight blue color LED string and the light bulb color LED string may also be connected in inverse-parallel (antiparallel) to each other. Specifically, each daylight color blue LED of the daylight blue color LED string and each light bulb color LED of the light bulb color LED string may be connected in inverse-parallel to each other, and the LEDs connected in inverse-parallel may be connected in series. And at least one resistor R11 for limiting the current may be connected inside or outside the series-connected LEDs.

The LED driving unit 120 drives switches to emit daylight blue color LEDs L11, L12, and L13 and light bulb color LEDs L21, L22, and L23. The LED driving unit 120 may be configured to turn on a plurality of switches to simultaneously emit daylight blue color LEDs or light bulb color LEDs at the same time. However, for consistency with the configuration of the LED unit 110 of FIG. 2, an operation of turning on a plurality of switches to emit daylight blue color LEDs and light bulb color LEDs at different times will be described below. An example of implementation of the LED driving unit 120 is illustrated in FIG. 3.

Referring to FIG. 3, the LED driving unit 120 includes a full bridge circuit comprised of two upper switches P11 and P21 and two lower switches N11 and N21. Specifically, it is composed of a first line and a second line, each upper switch P11 or P21 of the first line and the second line may be a P-channel transistor, for example, a P-channel MOSFET (Metal Oxide Semiconductor Field Effect transistor), and each lower switch N11 or N21 of the first line and the second line may be an N-channel transistor, for example, an N-channel MOSFET.

When a P-channel transistor is used for the upper switch and an N-channel transistor is used for the lower switch, noise immunity is improved compared to using, for example, 4 N-channel transistors, and in addition, a separate voltage required to drive the upper N-channel transistor may be eliminated.

According to the configuration of FIG. 3, the first P-channel transistor P11 of the first line and the second N-channel transistor N21 of the second line are simultaneously turned on, for example, to drive the daylight blue color LED string, and the second P-channel transistor P21 of the second line and the first N-channel transistor N11 of the first line may be simultaneously turned on, for example, to drive the light bulb color LED string,

The converter unit 130 supplies a driving voltage to the LED driving unit 120. A voltage rectified through a bridge circuit or a power factor corrected voltage is supplied to an input of the converter unit 130, and a voltage considering the on-voltage of two transistors and the number of connected LEDs is output to an output. For example, in this embodiment, DC 12V may be output.

The wireless communication unit 140 receives a radio signal from a remote controller (unshown). When receiving a radio signal, the wireless communication unit 140 provides the received radio signal to the signal control unit 150.

The signal control unit 150 operates the converter unit 130 when the input radio signal is powered on. As a result, DC 12V is supplied to the LED driving unit 120. In addition, when the signal control unit 150 outputs a control signal to the LED driving unit 120, the LED driving unit 120 operates and emits daylight blue color LEDs or light bulb color LEDs to indicate the color temperature along with lighting.

Specifically, the signal control unit 150 outputs a first control signal for simultaneous turning on the first P-channel transistor and the second N-channel transistor, for example, to drive the daylight blue color LED string, and outputs a second control signal for simultaneous turning on the second P-channel transistor and the first N-channel transistor, for example, to drive the light bulb color LED string.

The signal control unit 150 may output PWM (Pulse Width Modulation) signals as the first control signal and the second control signal to turn on the P-channel transistor and the N-channel transistor shown in FIG. 3.

On the other hand, in order to calculate the current flowing through the daylight blue color LED string and the light bulb color LED string, referring to FIG. 2, it is assumed that three LEDs and one resistor R11 are connected in series and a voltage of 12V is supplied thereto

When a current of 20 mA flows from daylight blue color LEDs L11, L12, and L13 and light bulb color LEDs L21, L22, and L23, if the rated voltage of light bulb color LED is, for example, 2.3V and the rated voltage of daylight blue color LED is, for example, 3.2V, the resistor R11 should be selected so that 6.9V is applied to the light bulb color LED string and 9.6V is applied to daylight blue color LED string. In this case, in order to flow 20 mA to each string, the resistance value of the resistor of the light bulb color LED string should be 255Ω, and the resistance value of the resistor of the daylight blue color LED string should be 120Ω.

However, when the resistor R11 for limiting the current is connected in the middle of the series-connected LEDs as illustrated in FIG. 2, or when resistors having the same resistance value are used for management with the daylight blue color LED string and the light bulb color LED string connected to respective resistors, the current flowing through the LED become different, so improvement is for that needed.

In particular, when at least one resistor R11 for limiting the current is connected in the middle of the series-connected LEDs as illustrated in FIG. 2, the selection of the resistor R11 should be considered first. In this case, the resistance value of the resistor R11 may be selected within a range of 120Ω to 255Ω, for example. Specifically, the resistance value of the resistor R11 may be selected such that a current value obtained by dividing the sum of the currents flowing through the daylight blue color LED string and the light bulb color LED string by 2 flows through the resistor R11. If the resistance value of the resistor R11 thus obtained is 200Ω, the predetermined range of the resistance value of the resistor R11 may be 180Ω to 215Ω. Therefore, it is possible to slightly improve the non-linearity problem between the voltage and the current of the LED.

However, even when the resistance value of the resistor R11 is selected so that the current value obtained by dividing the sum of the currents flowing through the daylight blue color LED string and the light bulb color LED string by 2 flows through the resistor R11, since the values of currents flowing through the daylight blue color LED string and the light bulb color LED string are different, so the light intensity of the daylight blue color LED and the light intensity of the light bulb color LED are different. Accordingly, it is impossible to properly implement the color temperature desired by the user.

In fact, after selecting the resistance value of the resistor R11, a current of 24 mA may flow through the light bulb color LED string and a current of 17 mA may flow through the daylight blue color LED string. In this case, it is necessary to correct the PWM on-width in consideration of the current actually flowing through the daylight blue color LED string and the light bulb color LED string. That is, since 17 mA/24 mA is 0.7 times, the on-width of the first control signal and the on-width of the second control signal may be corrected in consideration of this ratio. An example of this is shown in Table 1. Here, the period may be, for example, 100 μs.

TABLE 1

| | Color temperature | | | | | |
|---|---|---|---|---|---|---|
| | light bulb color | | neutral color | | daylight blue color | |
| | light bulb | daylight | light bulb | daylight | light bulb | daylight |
| | color | blue color | color | blue color | color | blue color |
| Brightness | LED ON | LED ON | LED ON | LED ON | LED ON | LED ON |
| Minimum | 14 | 0 | 12 | 16 | 0 | 14 |
| Median | 50 | 0 | 22 | 27 | 0 | 50 |
| Maximum | 96 | 0 | 39 | 54 | 0 | 96 |

As can be seen from Table 1 above, when only the daylight blue color or the light bulb color is turned on, the maximum 100% can be set to 96 μs considering the dead time, and the minimum 10% can be set to 14 μs considering the switching time, etc. In addition, even when only the daylight blue color or the light bulb color is turned on, it may be necessary to compensate for nonlinearity perceived by the human eye when controlling the brightness of each of the daylight blue color LED and the light bulb color LED, respectively. For example, in Table 1 above, the middle 50% may be set to 50 μs rather than half of 96 μs.

As can be seen from Table 1 above, when the LED emits only the daylight blue color or the light bulb color, only the brightness needs to be adjusted, so the on-width time may be the same. However, when the daylight blue color LEDs and the light bulb color LEDs are used to display the color temperature in neutral colors, the first control signal and the second control signal may be generated and output in consideration of the flowing current ratio of 0.7.

In this case, the on-time 22 μs of the light bulb color LEDs may be shorter than the value obtained by dividing by 2 the on-time 50 μs of the light bulb color LEDs when only the light bulb color LEDs of the same brightness are turned on, and the on-time 27 μs of the daylight blue color LEDs may be longer than the value obtained by dividing by 2 the on-time 50 μs of the daylight blue color LEDs when only the daylight blue color LED of the same brightness are turned on.

FIG. 4 illustrates an implementation example of an LED unit to which a capacitor is added to reduce flicker according to another embodiment of this disclosure.

So far, referring to FIG. 2, the case where the LED unit 110 is composed of one LED branch has been described as an example, but the LED branches may be connected in parallel to increase brightness. In this case, since LEDs of a plurality of LED branches are simultaneously turned on and off, flicker may occur. A circuit for reducing this flicker is illustrated in FIG. 4.

Referring to FIG. 4, the LED unit 110 may include four LED branches 402, 404, 406, and 408.

Both ends of the first LED branch 402 are directly connected to output lines of the LED driving unit 120, respectively. The upper end of the second LED branch 404 is connected to the upper output line of the LED driving unit 120 through the first capacitor C11, and the lower end of the second LED branch 404 is directly connected to the lower output line of the LED driving unit 120. The upper end of the third LED branch 406 is directly connected to the upper output line of the LED driving unit 120, and the lower end of the second LED branch 406 is connected to the lower output line of the LED driving unit 120 through the second capacitor C12. The upper end of the fourth LED branch 408 is connected to the upper output line of the LED driving unit 120 through the first capacitor C11, and the lower end of the second LED branch 408 is connected to the lower output line of the LED driving unit 120 through the second capacitor C12.

Meanwhile, the capacitance of the second capacitor may be greater than that of the first capacitor. Specifically, the capacitance value of the second capacitor may be twice as large as the capacitance value of the first capacitor. Accordingly, driving voltages having different delays may be supplied to the respective LED branches, thereby reducing flicker caused by simultaneous light emission of the LEDs.

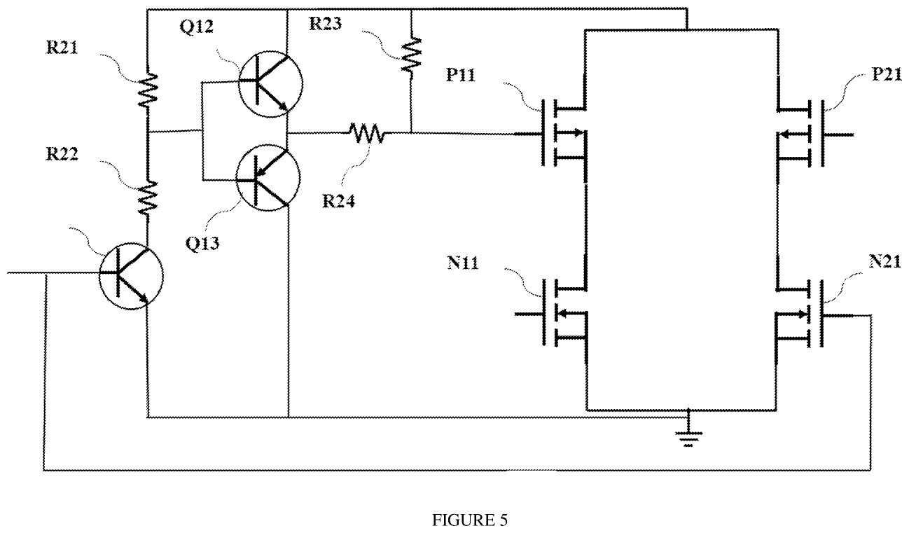

FIG. 5 illustrates an implementation example of an LED driving unit having a push-pull circuit according to another embodiment of this disclosure.

Referring to FIG. 5, the LED driving unit 120 may further include three transistors Q11, Q12, and Q13 and four resistors R21, R22, R23, and R24 to simultaneously turn on or off the P-channel transistor P11 of the first line together with the N-channel transistor N21 of the second line.

In order to drive the P-channel transistor P11 of the first line, the output of the complementary driving transistor set consisting of the NPN transistor Q12 and the PNP transistor Q13 is provided to the gate of the P-channel transistor P11 through a resistor R24. In detail, emitters of the NPN transistor Q12 and the PNP transistor Q13 may be connected to the gate of the P-channel transistor P11 through the resistor R24.

In addition, bases of the NPN transistor Q12 and the PNP transistor Q13 are connected to collector of the NPN transistor Q11 for input signal processing through a resistor R22, and a collector of the NPN transistor Q12 is connected to +12V voltage side, and the base of NPN transistor Q12 is connected to a +12V voltage side through a resistor R21. A resistor R23 is connected between the +12V voltage side and the gate of the P-channel transistor. The resistance value of the resistor R23 may be, for example, 10KΩ and the resistance value of the resistor R24 may be, for example, 30Ω. The resistor R24 may suppress an abrupt voltage change at the gate of the P-channel transistor P11.

In addition, a base of the NPN transistor Q11 for input signal processing may be connected to the output of the first control signal of the signal control unit 150. Also, a collector of the PNP transistor Q13 and an emitter of the NPN transistor Q11 are connected to the GND voltage side.

The operation of the circuit of FIG. 5 will be described below.

When a positive pulse of the PWM signal is provided from the signal control unit 150, the NPN transistor N21 is turned on. When the NPN transistor Q11 is turned on, the collector voltage of the NPN transistor Q11 drops to the vicinity of the GND voltage, and accordingly the base potentials of the NPN transistor Q12 and PNP transistor Q13 also drop to the vicinity of the GND voltage. As a result, the base potential of the NPN transistor Q12 becomes lower than its emitter potential, so the NPN transistor Q12 is turned off. On the other hand, the base potential of the PNP transistor Q13 becomes lower than its emitter potential, so the PNP transistor Q13 is turned on. As a result, the gate voltage of the P-channel transistor P11 becomes lower than its source voltage, so the P-channel transistor P11 is driven to be turned on.

While the PNP transistor Q13 is maintained in an on state, a current by the +12V voltage flows through the resistors R23 and R24, and thereby, the voltage across the resistor R23 makes it possible to keep the voltage at the base of the P-channel transistor P11 greater than the voltage at its source.

What is claimed is:

1. A LED lighting device comprises:
an LED unit comprising a first LED string made by connecting a plurality of first LEDs emitting light at a first color temperature in series and a second LED string made by connecting a plurality of second LEDs emitting light at a second color temperature different from the first color temperature in series, wherein the first LED string and the second LED string are connected in inverse-parallel;
a converter unit configured to supply a DC voltage to the first LEDs and the second LEDs;
a signal control unit configured to output a first control signal for emitting light of the first LEDs and a second control signal for emitting light of the second LEDs in consideration of the difference in operating voltage according to the color temperature of the first LEDs and the color temperature of the second LEDs, wherein the signal control unit configured to output the first control signal and the second control signal as PWM (Pulse Width Modulation) signals; and
a LED driving unit configured to provide the DC voltage supplied from the converter unit to the first LEDs or the second LEDs by turning on or off a plurality of switches according to the first control signal or the second control signal.

2. The LED lighting device according to claim 1, wherein the LED unit comprises at least one resistor connected to the inside or outside of the first LED string and the second LED string connected in inverse-parallel, and a current flowing through the first LED string and the second LED string flows in both directions through the at least one resistor.

3. The LED lighting device according to claim 2, wherein the resistance value of the at least one resistor is selected within a predetermined range of a value obtained by dividing the sum of currents flowing through the first LED string and the second LED string by 2.

4. The LED lighting device according to claim 2, wherein The LED driving unit comprises a full bridge circuit consisting of four switches.

5. The LED lighting device according to claim 4, wherein upper switches of the full bridge circuit are P-channel transistors, and lower switches of the full bridge circuit are N-channel transistors.

6. The LED lighting device according to claim 5, wherein the color temperature of the first LEDs is a light bulb color, and the color temperature of the second LEDs is a daylight blue color.

7. The LED lighting device according to claim 1, wherein an on-time of the first control signal for emitting the first LEDs is longer than an on-time of the second control signal for emitting the second LEDs when the first LEDs and the second LEDs alternately emit light to display the same brightness, respectively.

8. The LED lighting device according to claim 7, wherein the on-time of the first control signal is shorter than a value obtained by dividing by 2 an on-time of the same brightness in which only the first LEDs are turned on and the on-time of the second control signal is longer than a value obtained by dividing by 2 an on-time of the same brightness in which only the second LEDs are turned on.

9. The LED lighting device according to claim 8, wherein the signal control unit is configured to output the first control signal and the second control signal by compensating for nonlinearity recognized by the human eye when controlling the brightness of each of the first LEDs and the second LEDs.

10. The LED lighting device according to claim 2, wherein an LED branch comprises the first LED string, the second LED string and at least one resistor, and at least one capacitor is connected to prevent flicker between one end of at least one LED branch of the plurality of LED branches and the DC voltage side or the ground voltage side supplied from the converter unit.

11. The LED lighting device according to claim 10, wherein both ends of a first LED branch among the plurality of LED branches are directly connected to the DC voltage side and the ground voltage side supplied from the converter unit, a first capacitor is connected between one end of the second LED branch and the DC voltage side of the converter, a second capacitor is connected between one end of the third LED branch and the ground voltage side of the converter unit, and one end of the fourth LED branch is connected to a node to which the second LED branch and the first capacitor are connected and the other end of the fourth LED branch is connected to a node to which the third LED branch and the second capacitor are connected.

12. The LED lighting device according to claim 11, wherein the capacitance value of the second capacitor is twice as large as the capacitance value of the first capacitor.

13. The LED lighting device according to claim 5, wherein the LED driving unit further comprises a driving circuit configured to drive a first P-channel transistor of a first line with an on signal of a second N-channel transistor of a second line.

14. The LED lighting device according to claim 13, wherein the driving circuit comprises a complementary transistor set comprised of an NPN transistor and a PNP transistor to drive the first P-channel transistor.

15. The LED lighting device according to claim 14, wherein the driving circuit further comprises a first resistor connected between the DC voltage supplied from the converter unit and a base of the first P-channel transistor or a second resistor connected between an output of the complementary transistor set and the base of the first P-channel transistor.
